(19) United States
(12) Patent Application Publication
(10) Pub. No.: US 2016/0080138 A1
(43) Pub. Date: Mar. 17, 2016

(54) METHOD AND APPARATUS FOR TIMING SYNCHRONIZATION IN A DISTRIBUTED TIMING SYSTEM

(71) Applicant: TELEFONAKTIEBOLAGET L M ERICSSON (PUBL), Stockholm (SE)

(72) Inventor: Daniel Christian BIEDERMAN, Saratoga, CA (US)

(21) Appl. No.: 14/580,003

(22) Filed: Dec. 22, 2014

Related U.S. Application Data
(60) Provisional application No. 62/051,429, filed on Sep. 17, 2014.

(51) Int. Cl. H04L 7/00

(52) U.S. Cl. CPC H04L 7/0037

(57) ABSTRACT

In one aspect of the teachings herein, a timing circuit detects the assertion of an incoming timing pulse signal at a timing resolution higher than that afforded by the sampling clock signal used to detect the assertion event. To do so, the timing circuit uses delay circuitry to obtain incrementally delayed versions of the incoming timing pulse signal or sampling clock signal. The delay increments are fractions of the sampling clock period and the timing circuit uses the delayed versions to determine a timing difference between actual assertion time of the incoming timing pulse signal and the sampling clock edge at which assertion of the incoming timing pulse signal is detected. In another aspect, a timing circuit uses similar delay techniques to control the timing of an outgoing timing pulse signal at a timing resolution higher than that afforded by the clock circuitry associated with generating the outgoing signal.

### RELATED APPLICATIONS

This application claims priority under 35 U.S.C. 119 from the U.S. provisional patent application filed on Sep. 17, 2014 and assigned 62/051,429, which application is incorporated by reference herein.

### TECHNICAL FIELD

The present invention generally relates to timing synchronization, and particularly relates to timing synchronization in a distributed timing system.

### BACKGROUND

The telecommunications industry has long relied upon Global Positioning System, GPS, technology for mobile backhaul synchronization. However, some in the industry would prefer not to be tied to GPS, given its ownership and control by the United States government. For this reason and others, telecommunication companies are interested in using technologies like Synchronous Ethernet or “SYNC-E” and the IEEE 1588 Standard for “A Precision Clock Synchronization Protocol for Networked Measurement and Control Systems”, to meet their network synchronization needs.

IEEE 1588, which has been around for a number of years, is a protocol for maintaining synchronization between distributed “devices” that are communicatively interconnected. Here, the term “device” is used generically and may denote geographically distributed nodes in a communications network or different cards and backplanes within a rack of circuitry. According to IEEE 1588, master and slave clocks exchange timing messages to maintain synchronization between the slave clocks and the corresponding master clock. A given device may have both master and slave clock ports, and may act as a synchronization slave with respect to one device and act as a synchronization master with respect to another device.

Critically, IEEE 1588 introduced hardware-based time stamping as a mechanism to significantly improve the synchronization between devices. With hardware time stamping, each device maintains a continuous, current local time in seconds and nano-seconds, e.g., based on a 1 GHz clock signal, and uses this time to time stamp the arrival and departure times of timing messages exchanged between devices having a master/slave synchronization relationship. Moreover, the message protocol implemented by IEEE 1588 enables the master and slave devices to estimate the path delays between them. The ability to estimate the path delays, also sometimes referred to as the “wire” delays, enables synchronization slaves to “see” the difference between their local times and the local time at the synchronization master at a high resolution, e.g., at the nanosecond resolution.

However, this level of precision specified in the standard makes implementation of these technologies challenging. Exceedingly careful design and implementation is needed to meet the applicable timing requirements. Timing performance problems arise for a variety of reasons, such as from practical limits on the quality or precision of the timing circuitry included in the devices making up the distributed timing system. Further, even where clock circuitry of suitable precision and stability is used, the failure to address timing jitter and other clocking errors may prevent compliance with the applicable timing requirements over a broad range of operating conditions and component tolerances.

### SUMMARY

In one aspect of the teachings herein, a timing circuit detects the assertion of an incoming timing pulse signal at a timing resolution higher than that afforded by the sampling clock signal used to detect the assertion event. To do so, the timing circuit uses a delay circuit to obtain incrementally delayed versions of the incoming timing pulse signal or sampling clock signal. The delay increments are fractions of the sampling clock period, and the timing circuit uses the delayed versions to determine a timing difference between actual assertion time of the incoming timing pulse signal and the sampling clock edge at which assertion of the incoming timing pulse signal is detected. In another aspect, a timing circuit uses similar delay techniques to control the timing of an outgoing timing pulse signal at a timing resolution higher than that afforded by the clock circuitry associated with generating the outgoing signal.

In an example embodiment, a method in a timing circuit includes detecting assertion of an incoming timing pulse signal, via a sampling clock edge of a sampling clock signal having a sampling clock period, and generating delayed versions of the incoming timing pulse signal or the sampling clock signal. Here, the delayed versions are separated by incremental delays that are fractions of the sampling clock period. Correspondingly, the method in this example further includes determining the state of the incoming timing pulse signal for each of the incremental delays, estimating a timing difference between an actual assertion time of the incoming timing pulse signal and the sampling clock edge at which assertion of the incoming timing pulse signal is detected, based on the determined states, and compensating a timing operation of the timing circuit according to the estimated timing difference.

In another example embodiment, a timing circuit includes an input connection configured to receive an incoming timing pulse signal and processing circuitry that is configured to detect assertion of the incoming timing pulse signal, via a sampling clock edge of a sampling clock signal having a sampling clock period. Further, the processing circuitry is configured to generate delayed versions of the incoming timing pulse signal or the sampling clock signal, where the delayed versions are separated by incremental delays that are fractions of the sampling clock period. Still further, the processing circuitry is configured to determine the state of the incoming timing pulse signal for each of the incremental delays, estimate a timing difference between an actual assertion time of the incoming timing pulse signal and the sampling clock edge at which assertion of the incoming timing pulse signal is detected, based on the determined states, and compensate a timing operation of the timing circuit according to the estimated timing difference.

In yet another example embodiment, an output signal circuit includes a propagation delay circuit configured to provide a plurality of delayed versions of an outgoing timing pulse signal at respective incremental delays. The propagation delay circuit provides the delayed versions of the outgoing timing pulse signal at respective delay taps corresponding to the incremental delays. Further included in the output signal circuit is a selection circuit that is configured to couple a selected one of the delayed versions of the outgoing timing pulse signal to an output port of the output signal circuit, and a control circuit that is configured to control the selection circuit. More particularly, the control circuit is configured to determine a timing adjustment and to correspondingly control the selection circuit to select the delayed version of the outgoing timing pulse signal that corresponds to the timing adjustment, as the “selected one” of the delayed versions of the outgoing timing pulse signal.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of one embodiment of a timing circuit according to the teachings herein.

FIG. 2 is a logic flow diagram of one embodiment of a method implemented by a timing circuit, such as the one shown in FIG. 1.

FIG. 3A is a diagram of an example timing relationship between a timing pulse signal assertion and a sampling clock edge-based capture of that event, while FIG. 3B is a block diagram of one embodiment of a delay circuit yielding a capture resolution for the assertion event that is finer than the timing resolution of the sampling clock.

FIG. 4 is a block diagram of another embodiment of a delay circuit yielding a capture resolution for the assertion event that is finer than the timing resolution of a sampling clock.

FIG. 5 is a block diagram of another embodiment of a delay circuit yielding a capture resolution for the assertion event that is finer than the timing resolution of the sampling clock.

FIG. 6 is a block diagram of one embodiment of a distributed timing system that includes at least one timing entity having a timing circuit configured according to the teachings herein.

FIG. 7 is a block diagram of another embodiment of a delay circuit yielding a capture resolution for an assertion event that is finer than the timing resolution of the sampling clock.

FIG. 8 is a block diagram of one embodiment of processing modules for implementing a timing circuit, such as the one shown in FIG. 1.

FIG. 9 is a block diagram of one embodiment of a dual-register configuration as may be used in a capture register in a timing circuit, such as the one shown in FIG. 1.

FIG. 10 is a block diagram of a delay circuit for calibration with respect to the use of a delay circuit for improved timing resolution in a timing circuit, such as the one shown in FIG. 1.

FIG. 11 is a block diagram of one embodiment of an output signal circuit configured for controlling output signal timing.

### DETAILED DESCRIPTION

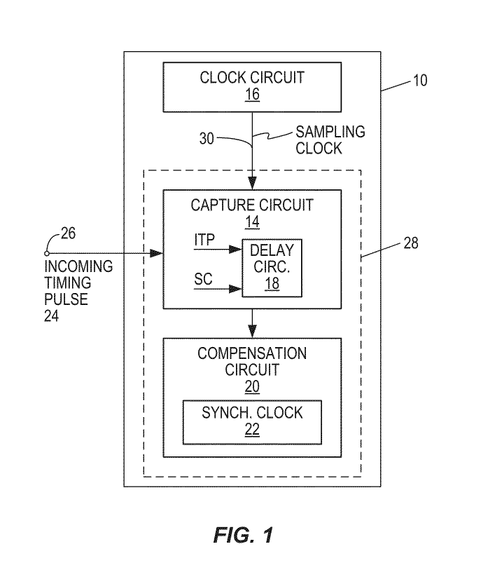

FIG. 1 illustrates one embodiment of a timing circuit 10, as contemplated in this disclosure. The timing circuit 10 provides an advantageous mechanism for detecting the assertion of an incoming signal, such as an incoming asynchronous timing pulse. The mechanism provides precise signal “arrival time” detection at the hardware level, and this improved accuracy is used, for example, to make more accurate timing synchronization adjustments.

According to the illustrated example, the timing circuit 10 includes a capture circuit 14 and an associated clock circuit 16. The capture circuit 14 includes a delay circuit 18 and is associated with a compensation circuit 20. The compensation circuit 20 is configured to compensate a timing of the timing circuit 10. For example, according to the non-limiting details seen in the diagram, the compensation circuit 20 includes or is associated with a synchronization clock 22 that it adjusts or otherwise compensates. The synchronization clock 22 comprises, for example a free-running timer/counter used for maintaining the synchronization of a device within a distributed timing network.

For an incoming timing pulse signal 24, as received on an input connection 26, the capture circuit 14 and the compensation circuit 20 together operate as “processing circuitry 28”. Advantageously, the processing circuitry 28 determines a timing compensation for the timing circuit 10—e.g., for the synchronization clock 22—based on detecting the assertion of the incoming timing pulse signal 24 at a timing resolution better than that afforded by the sampling clock signal 30, which is output by the clock circuit 16 and which clocks the capture circuit 14. In other words, the clock period of the sampling clock signal 30 defines the base timing resolution of the capture circuit 14, by providing clock-edge based detection of the assertion of the incoming timing pulse signal 24.

Advantageously, the delay circuit 18 improves the base timing resolution, without requiring a more precise or faster clock. The delay circuit 18 provides the timing resolution improvement by creating delayed versions of the incoming timing pulse signal 24 or the sampling clock signal 30. These delayed versions are at incremental delays corresponding to fractions of the sampling clock period. The delay circuit 18 receives one or both of the incoming timing pulse signal 24 and the sampling clock signal 30, for use in generating these delayed signal versions. The incoming timing pulse signal 24 is abbreviated as “ITP” in the diagram, and the sampling clock signal 30 is abbreviated as “SC” in the diagram.

In more detail, the delay circuit 18 generates incrementally delayed versions of the incoming timing pulse signal 24 or sampling clock signal 30, where the incremental delays are fractions of the clock period of the sampling clock signal 30. The incrementally delayed signal versions allow the timing circuit 10 to estimate the timing difference between the actual assertion of the incoming timing pulse signal 24 and the sampling clock edge at which that assertion was registered or otherwise detected.

For example, the incoming timing pulse signal 24 may arrive—be asserted—coincidently with a sampling clock edge. However, because of metastability issues, it may be that an edge-detection circuit within the capture circuit 14 may not “see” the assertion until the next sampling edge of the sampling clock signal 30. Assuming one sampling edge per clock cycle, the edge-based detection of the assertion time would, in this case, be delayed by one clock period. Of course, the delay circuit 18 may also exhibit metastability issues, such that the assertion time of the incoming timing pulse signal 24 should be observable at a given incremental delay, but instead is observable at a subsequent incremental delay.

Even so, however, because the incremental delays are fractions of the clock period, the timing circuit 10 ultimately still detects the assertion time of the incoming timing pulse signal 24 at a higher resolution than is afforded solely by edge-based detection at the sampling clock frequency. Thus, the estimated timing difference has a resolution finer than the sampling clock period and thus reduces jitter-related errors associated with using clock-edge based detection of the assertion event.

While not shown in the illustration, it will be understood that the timing circuit 10 may be implemented, for example, in a device operating in a distributed timing network, such as an IEEE 1588 based network. In such implementations, among its various advantages, the timing circuit 10 may be understood as eliminating or at least greatly reducing jitter errors in signal arrival time detection, based on determining the timing difference between the actual assertion or arrival time of the incoming timing pulse signal 24 and clock-edge based detection of that assertion.

The timing circuit 10 of FIG. 1 includes an input port or connection 26 configured to receive an incoming timing pulse signal 24, and processing circuitry 28 that is configured to detect assertion of the incoming timing pulse signal 24 via a sampling clock edge of a sampling clock signal 30. The incoming timing pulse signal 24 is, for example, broadcasted or otherwise transmitted by a first timing entity in a distributed timing system, as a mechanism for a second timing entity to reset or otherwise update its local time.

The second timing entity in this non-limiting example includes the timing circuit 10 and uses the sampling clock signal 30 to drive its local time keeping. Assertion of the incoming timing pulse signal 24 in this example context is asynchronous with respect to the sampling clock signal 30, and a function of the second timing entity is to detect the arrival time of the incoming timing pulse signal 24 as accurately as possible, so that its local time adjustment is accurate. The sampling clock signal 30 has a defined sampling clock period, such as a one-nanosecond period corresponding to a sampling clock frequency of 1 GHz.

Regardless of the particular clock frequency at issue, the processing circuitry 28 is configured to generate a plurality of delayed versions of the incoming timing pulse signal 24 or the sampling clock signal 30. As explained earlier, these delayed signal versions are separated by incremental delays that are fractions of the sampling clock period. For example, the incremental delays may be tenths or less of the clock period, but the incremental delays need not all be the same. Correspondingly, the processing circuitry 28 is configured to determine the state of the incoming timing pulse signal 24 for each of the incremental delays.

Here, it should be noted that the “plurality” of delayed versions may be a subset of a larger plurality of delayed versions. For example, the processing circuitry 28 may create fifteen, twenty, or even more incrementally delayed signal versions, but may evaluate only a subset of these delays as said “plurality”. As such, the teachings herein regarding the evaluation of the state of the incoming timing pulse signal 24 at “each” of the plurality of delays does not mean that the processing circuitry 28 must make an evaluation at every single signal delay it generates.

Thus, it should be understood that the processing circuitry 28 creates a number of delayed signal versions and evaluates at least some of that number of delays. In particular, the processing circuitry 28 determines the state of the incoming timing pulse signal 24 at each of these “at least some delays.” By generating those delays to cover increments of the sampling clock period at offsets relative to the sampling clock edge that “caught” or detected the incoming timing pulse signal assertion, and by capturing that state of the incoming timing pulse signal 24 at those delays, the processing circuitry 28 can observe from the captured states at which incremental delay assertion of the incoming timing pulse signal 24 occurred relative to the sampling clock edge at which that assertion was registered or detected.

Thus, the processing circuitry 28 is configured to estimate the timing difference between the actual assertion time of the incoming timing pulse signal 24 and the sampling clock edge at which assertion of the incoming timing pulse signal 24 is detected, based on the determined states—i.e., the states of the incoming timing pulse signal 24 determined for each of the incremental delays evaluated by the processing circuitry 28. Correspondingly, the processing circuitry 28 is configured to compensate a timing operation of the timing circuit 10 according to the estimated timing difference.

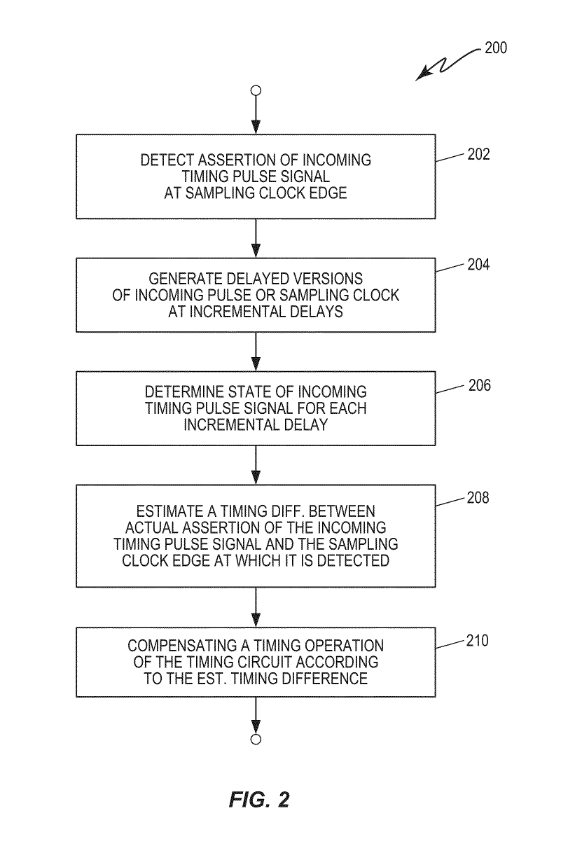

Of course, the circuit details shown in FIG. 1 represent an example embodiment. Broadly, it is contemplated to implement a method 200 in a timing circuit 10, as shown in FIG. 2. The method 200 includes detecting (Block 202) assertion of an incoming timing pulse signal 24, via a sampling clock edge of a sampling clock signal 30 having a sampling clock period, and generating (Block 204) delayed versions of the incoming timing pulse signal 24 or the sampling clock signal 30, wherein the delayed versions are separated by incremental delays that are fractions of the sampling clock period. The edge-based or clock-based detection of the incoming timing pulse signal 24 comprises latching the first sampling clock signal edge at which the capture circuit 14 detects the incoming timing pulse signal 24 in the asserted state.

The method 200 further includes determining (Block 206) the state of the incoming timing pulse signal 24 for each of the incremental delays, and estimating (Block 208) a timing difference between the actual assertion time of the incoming timing pulse signal 24 and the sampling clock edge at which assertion of the incoming timing pulse signal 24 is detected, based on the determined states. Still further, the method 200 includes compensating (Block 210) a timing operation of the timing circuit 10 according to the estimated timing difference.

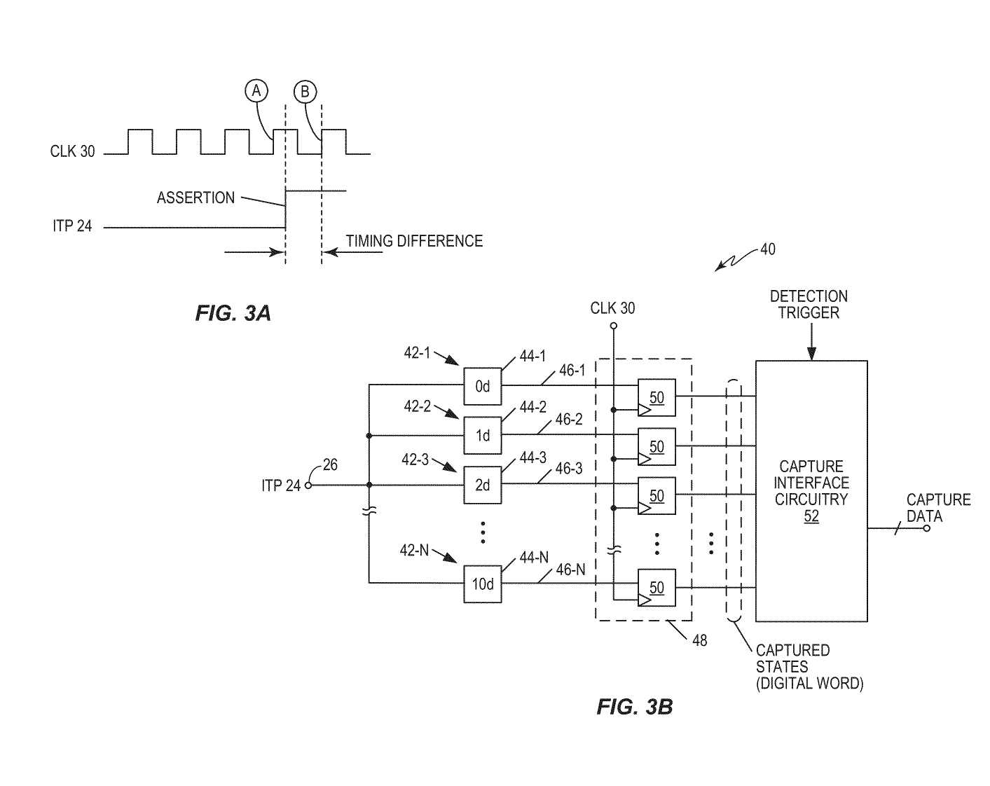

To better understand these operational aspects, consider the timing diagram of FIG. 3A, which depicts an example assertion of the incoming timing pulse signal 24—ITP 24—relative to the sampling clock signal 30. As a non-limiting example, assume that the state of the incoming timing pulse signal 24 is detected at rising edges of the sampling clock signal 30. In the example of FIG. 3A, the actual assertion time of the incoming timing pulse signal 24 lies between respective rising clock edges “A” and “B” of the sampling clock signal 30. This example assumes that clock-based detection of the incoming timing pulse signal 24 is based on rising clock edges but that is a non-limiting example detail. Falling edge or rising and falling edge detection also may be used.

The assertion will not be detected—“caught” or “registered”—on the clock edge “A” and instead will be detected on the subsequent rising edge “B” of the sampling clock signal 30. “Assertion” here means positive or negative assertion. Further, in one or more example embodiments, the term “state” means the binary state. However, determining “states” of the incoming timing pulse signal 24 also may denote multistate detection or a more generalized analog detection. Thus, the term “state” can be understood as meaning the particular condition that the subject signal is in at specific times, e.g., at specific delay increments.

With respect to FIG. 3A, the circuitry illustrated in FIG. 3B provides a mechanism for the timing circuit 10 to estimate the offset between the actual assertion of the incoming timing pulse signal 24 and the clock edge “B” of the sampling clock signal 30 at which the assertion is detected. FIG. 3B illustrates a type of propagation delay circuit 40, which shall be understood as a non-limiting example of the delay circuit 18 introduced in FIG. 1. The propagation delay circuit 40 includes a number of parallel branches 42, e.g., branches 42-1, 42-2, etc. Each branch 42 imparts a different time delay to the incoming timing pulse signal 24. The imparted delays are fractions of the clock period of the sampling clock signal 30. For example, a delay element 44-1 in the first branch 42-1 imparts a delay of zero “d”, meaning that it operates as a “wire” or zero delay pass-through for the incoming timing pulse signal 24. The corresponding delay tap 46-1 thus serves as a zero-delay tap.

The second branch 42-2 includes a delay element 44-2 that imparts a delay of two “d”, where “d” is, e.g., ten percent of the nominal clock period. Thus, the output delay tap 46-2 corresponding to the delay element 44-2 is delayed by an increment of ten percent of the clock period as compared to the zero-delay output seen on the delay tap 46-1 output from the delay element 44-1. Successive delay taps 46 may thus correspond to successive, incrementally delayed versions of the incoming timing pulse signal 24. It is to be noted that the overall time span of the propagation delay circuit 40—i.e., its maximum propagation delay—may span the worst-case clock period or may accommodate a range of sampling clock periods. Further, the time steps or differences between the incremental delays will reflect a desired timing resolution.

The propagation delay circuit 40 of FIG. 3B includes a parallel set 48 of capture registers 50—e.g., data flip-flops. Each capture register 50 is clocked by the sampling clock signal 30 and each capture register 50 has its data input corresponding to a respective one of the delay taps 46. As such, the capture circuit 14 captures the state of the incoming timing pulse signal 24 at clock edges of the sampling clock signal 30. This arrangement provides a mechanism for capturing the state of the incoming timing pulse signal 24 at a plurality of delays relative to the sampling clock edge at which assertion of the incoming timing pulse signal 24 is detected.

Thus, the set 48 of capture registers 50 captures the states of the delayed versions of the incoming timing pulse signal 24 at the sampling clock edge at which assertion of the incoming timing pulse signal 24 is detected. Correspondingly, the illustrated capture interface circuitry 52 may be used to record or otherwise buffer these captured states, for evaluation.

In more detail, a “first” capture register 50 captures the state of the zero delay version of the incoming timing pulse signal 24 at the sampling clock edge, a “second” capture register 50 captures the state of the one-delay version of the incoming timing pulse signal 24 at the sampling clock edge, and so on. By looking at which one(s) of the delayed signal versions are asserted when the relevant sampling clock edge clocks the capture registers 50, the timing circuit 10 detects the timing difference between the actual assertion time of the incoming timing pulse signal 24 and the sampling clock edge at which such assertion is detected.

For example, in the context of FIG. 3A, assume that the incoming timing pulse signal 24 is asserted in advance of the sampling clock edge “B” by a time falling between the “5 d” and “6 d” delays of the propagation delay circuit 40. As such, the capture register 50 associated with the 5 d delay would capture the asserted state for the incoming timing pulse signal 24 and the capture register 50 associated with the 6 d and greater delays would capture the un-asserted state for the incoming timing pulse signal 24. By observing these captured states, the timing circuit 10 estimates that the incoming timing pulse signal 24 was asserted in advance of the sampling clock edge “B” at a time equal to the 5 d delay.

The timing circuit 10 would be configured with the time value of the unit delay value “d” and would, more generally be configured with values corresponding to the absolute or relative delay values of each branch 42 of the propagation delay circuit 40. Such configuration data enables the timing circuit 10 to resolve the actual assertion time at a timing resolution finer than that afforded by the sampling clock signal 30, and yet advantageously does not require the use of a faster clock signal.

Broadly, then, in one or more embodiments, the delay circuit 18 comprises a type of propagation delay circuit, and the processing circuitry 28 is configured to generate the delayed versions of the incoming timing pulse signal 24 or the sampling clock signal 30 by propagating the incoming timing pulse signal 24 or the sampling clock signal 30 through delay stages having delay taps corresponding to the incremental delays. The processing circuitry 28 in such embodiments is configured to determine the state of the incoming timing pulse signal 24 for each of the incremental delays by capturing the state of the incoming timing pulse signal 24 at each incremental delay, and is configured to determine from the captured states the incremental delay or delays at which assertion of the incoming timing pulse signal 24 is observed. The timing circuit 10 estimates the timing difference between the actual and the registered assertion of the incoming timing pulse signal 24 based on these observations.

In some embodiments, the delayed signal versions at issue are created from the sampling clock signal 30 rather than from the incoming timing pulse signal 24. Correspondingly, the processing circuitry 28 is configured to determine the state of the incoming timing pulse signal 24 for each of the incremental delays based on being configured to apply the incoming timing pulse signal 24 to the data or capture inputs of a set of capture registers, and to clock respective ones of the registers using the incrementally delayed versions of the sampling clock signal 30.

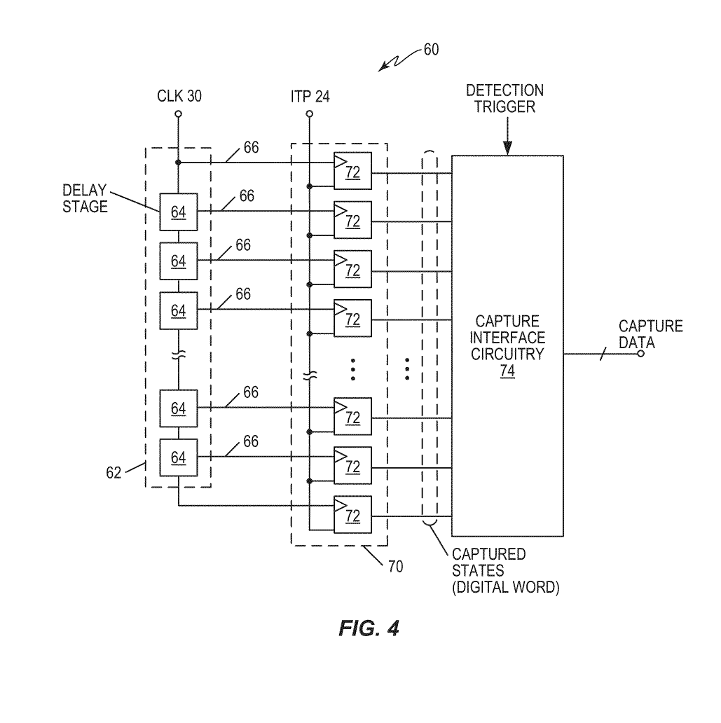

Such an arrangement is shown in FIG. 4, which uses a series-delay based propagation delay circuit 60 rather than the parallel-delay based propagation delay circuit 40 seen in FIG. 3B. In particular, one sees a tapped delay line 62 comprising a series of delay stages 64, each providing a corresponding delay tap 66. The incrementally delayed tap outputs drive a parallel set 70 of capture registers 72. The set 70 of capture registers 72 captures the state of the incoming timing pulse signal 24 at incremental delays, as defined by the delayed versions of the sampling clock signal 30.

Referring back to FIG. 3A, the sampling clock edge “A” is propagated through the tapped delay line 62. In an example where each delay stage 64 imparts a unit time delay of “d”, this arrangement creates sampling clock edges at incremental, successive delays of 0 d, 1 d, 2 d, 3 d, and so on. Assuming that assertion of the incoming timing pulse signal 24 occurs at a time between 5 d and 6 d delays after the sampling clock edge “A”, the capture registers 72 corresponding to delays 0 d through 5 d will capture the incoming timing pulse signal 24 in the un-asserted state, while the capture registers 72 corresponding to delays of 6 d and greater will capture the incoming timing pulse signal 24 in the asserted state.

By observing this boundary or change in the captured states, the timing circuit 10 ascertains that the actual assertion of the incoming timing pulse signal 24 lagged the sampling clock edge “A” by a time difference equal to 6 d unit times. Here, the capture circuit 14 includes, for example capture interface circuitry 74 to “read” the digital word formed by the captured states of the incoming timing pulse signal 24. The capture interface circuitry 74, for example, latches or otherwise records the outputs from the set 70 of capture registers 72 in response to a detection trigger signal. In turn, the detection trigger signal may be directly or indirectly derived from the sampling clock edge at which assertion of the incoming timing pulse signal 24 is detected.

Notably, in the above example, the sampling clock edge that captures the actuation assertion of the incoming timing pulse signal 24 at the fractional clock resolution is not the sampling clock edge at which the larger timing circuit 10 registers that assertion. In more detail, in FIG. 3A, the clock-based registration or detection of the incoming timing pulse signal 24 occurs on the sampling clock edge “B”, but with the circuit arrangement seen in FIG. 4, it is the preceding sampling clock edge “A” that captures the timing difference between sampling clock edge “B” and the actual assertion of the incoming timing pulse signal 24. However, the fundamental operation of the capture circuit 14 and its included delay circuit 18 are the same, regardless of whether the fractional captures lead or lag the actual sampling clock edge at which the incoming timing pulse signal 24 is detected as being asserted.

Fundamentally, with clock-based detection of incoming timing pulse signal assertion, there will be a particular clock edge of the sampling clock signal 30 at which the assertion is registered, and the capture circuit 14 uses incrementally delayed versions of the sampling clock signal 30 or the incoming timing pulse signal 24 to estimate the timing difference between that sampling clock edge and the actual assertion time. The sampling clock edge at which the assertion is detected may be the same clock edge used to capture the state of the incoming timing pulse signal 24 at the incremental delays—e.g., as seen in FIG. 3B—or an adjacent clock edge may be used—as seen in FIG. 4, which propagates the sampling clock signal 30 through the tapped delay line 62 to obtain a multiplicity of delayed clock edges.

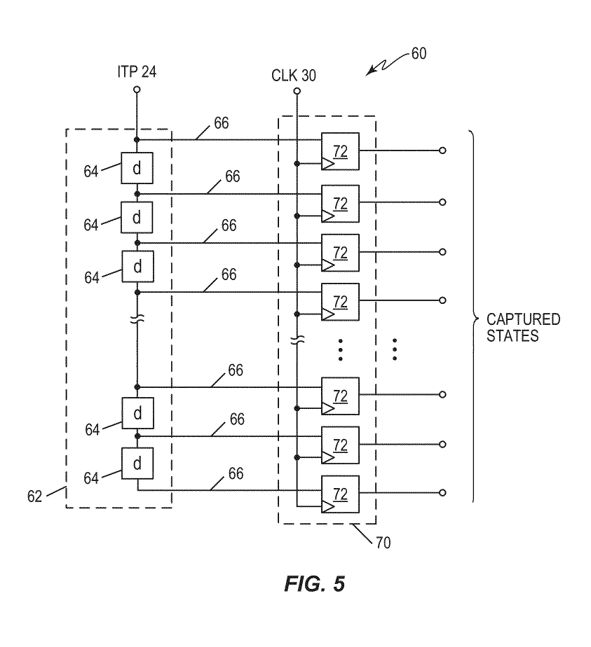

For further illustration of these variations, FIG. 5 illustrates the case where the incoming timing pulse signal 24 is propagated through the tapped delay line 62, rather than the sampling clock signal 30. Consider operation of the set 70 of capture registers 72 with this connection arrangement with respect to the timing example of FIG. 3A. Because actual assertion of the incoming timing pulse signal 24 occurs after the sampling clock edge “A”, the set 70 of capture registers 72 will uniformly capture the sampling clock signal 24 in the un-asserted state. However, assertion occurs some time in advance of the sampling clock edge “B”, and the leading edge of that assertion will begin propagating through the tapped delay line 62 in advance of the sampling clock edge “B”.

Assuming a uniform unit delay of “d” for each delay stage 64, the depth of that propagation through the tapped delay line 62 is directly proportional to how far in advance of the sampling clock edge “B” the assertion occurs. Thus, assuming that the assertion occurs sometime after the sampling clock edge “A” and sometime before the sampling clock edge “B”, the leading edge of the incoming timing pulse signal assertion will have propagated to some depth, e.g., 4 d deep, 5 d deep, etc., into the tapped delay line 62, in advance of the sampling clock edge “B”. The set 70 of the capture registers 72 captures the state of the incoming timing pulse signal 24 at the corresponding incremental delays between the sampling clock edges “A” and “B”.

Detecting the assertion of the incoming timing pulse signal 24 at the sampling clock edge “B” causes the timing circuit 10 to read or otherwise evaluate the relevant captured states e.g., to evaluate the digital word provided as the output of the capture registers 72 for the sampling clock edge “B”. In so doing, the timing circuit 10 determines the state of the incoming timing pulse signal 24 for each of the incremental delays, and estimates a timing difference between an actual assertion time of the incoming timing pulse signal 24 and the sampling clock edge at which assertion of the incoming timing pulse signal 24 is detected, based on the determined states. That is, the timing circuit 10 determines from the captured states the incremental delay or delays at which the assertion is observed.

Referring back to FIG. 4 momentarily, the capture circuit 14 and/or the compensation circuit 20 may be arranged to generate the detection trigger signal in response to its clock-edge based detection of the incoming timing pulse signal assertion, to cause capture interface circuitry 74 to read and save the capture register contents before the next sampling clock edge. In one such embodiment, the capture interface circuitry 74 may comprise digital circuitry within a microprocessor, digital signal processor, ASIC, FPGA, or other digital processing circuit used to implement at least a portion of the timing circuit 10.

Alternatively, the capture interface circuitry 74 may buffer successive digital words, as output from the capture registers 72 over successive sampling clock periods, and then evaluate the buffer contents relevant to the sampling clock edge at which assertion of the incoming timing pulse signal 24 was detected by the timing circuit 10. The relevant buffer contents here may be the contents corresponding to the actual sampling clock edge at which the assertion was registered at large by the timing circuit 10. This case applies in the context of FIG. 3B and FIG. 4, for example. Alternatively, the relevant buffer contents may correspond to the immediately preceding sampling clock edge, such as in the case in the context of FIG. 5.

In either case, the processing circuitry 28 is configured to estimate the timing difference between the actual assertion time of the incoming timing pulse signal 24 and the sampling clock edge at which assertion of the incoming timing pulse signal 24 is detected, by identifying from the bit values in the digital word the incremental delay or delays at which the assertion of the incoming timing pulse signal is observed. For example, with reference again to FIG. 3B, assume that the topmost branch 42-1 in the propagation delay circuit 40 imparts a delay of zero “d” and that the incremental delay imparted by each further branch 42 imparts delays successively incremented by “d”—e.g., 1 d, 2 d, 3 d, and so on. Further, assume that there are a total of ten branches 42, such that the set 48 of capture registers 50 outputs a ten-bit digital word {b0, b1, b2, . . . , b9}. Here, “b0” is a zero-delay bit, “b1” is a 1 d-delay bit, “b2” is a 2 d-delay bit, and so on.

In an example capture event, and assuming positive logic by way of non-limiting example, the digital word reads as follows: {1, 1, 1, 1, 1, 0, 0, 0, 0, 0}. The boundary between asserted bits and non-asserted bits falls at the b4-b5 bit positions. As bit b4 corresponds to a delay of 4 d, the timing circuit 10 estimates that the actual assertion of the incoming timing pulse signal 24 occurred 4 d time units before the sampling clock edge at which such assertion was actually detected by the timing circuit 10. The timing difference would thus be calculated by the timing circuit 10 as being four times the unit of time represented by “d”.

As a further refinement encompassed by these teachings, the timing difference could be estimated as 4 d plus a delta value that places the actual estimate in between the 4 d and 5 d delay values. For example, assuming uniform delay increments, the timing difference may be estimated as 4.5 d, meaning that the actual assertion time is assumed to fall midway between the 4 d and 5 d values.

Of course, with respect to FIG. 3B and in the larger context of this disclosure, the incremental delays at issue need not be uniform. Irrespective of whether uniform delay increments are used, in one or more embodiments, the processing circuitry 28 captures a set of digital states—a digital word—that reflects the state of the incoming timing pulse signal 24 at a plurality of delay increments in advance of the sampling clock edge at which assertion of the incoming timing pulse signal 24 is registered or otherwise detected by the processing circuitry 28. These incremental delays are fractions of the sampling clock period and the processing circuitry 28 is configured to estimate the timing difference between the actual assertion time of the incoming timing pulse signal 24 and the sampling clock edge at which assertion of the incoming timing pulse signal 24 is detected, by identifying from the bit values in the digital word the incremental delay or delays at which the assertion of the incoming timing pulse signal 24 is observed.

Thus, whether the incoming timing pulse signal 24 is delayed, or the sampling clock signal 30 is delayed, the processing circuitry 28 is configured to estimate the timing difference by identifying at which incremental delay or delays the incoming timing pulse signal 24 is observed in an asserted state. From this observation, the processing circuitry 28 estimates the timing difference based on a known cumulative delay associated with the identified incremental delay(s).

With FIGS. 4 and 5 in mind as non-limiting examples, it is assumed that each delay stage 64 has a signal propagation delay of 0.1 nanoseconds. It is further assumed that the sampling clock signal 30 is a 1 GHz clock signal. With these assumptions, in an ideal case, the tapped delay line 62 only needs to provide ten delay taps 66 to catch the relevant signal edge. However, a greater number of delay taps 66 may be used, i.e., by chaining a greater number of delay stages 64, which are also referred to as “delay buffers”. For example, the tapped delay line 62 may provide thirteen or more delay taps 66. The extra taps allow for delay variations arising from, for example, process, voltage, and/or temperature variations, which are often referred to collectively as “PVT” variations.

In general, the delay circuit 18 is configured with enough delay range to capture values corresponding to a single cycle of the sampling clock signal 30 in consideration of the “worst case” parameters over a defined PVT range. It might also be noted that the delay circuit 18 may be dynamically configurable, for example, either by activating or using a configured subset among a larger number of possible delays, or by decimating the delay capture results, to provide captured states corresponding to only a subset of a larger, captured set.

Further, with respect to capturing the state of the incoming timing pulse signal 24 at incremental delays relative to the clock edge of the sampling clock signal 30 at which assertion of the incoming timing pulse signal 24 is detected, it may be noted that that same clock edge may be used to clock the capture circuitry, or, for example, the preceding clock edge may be used to clock the capture circuitry. In the former case, the timing circuit 10 only needs to “freeze” or latch the captured states of the incoming timing pulse signal 24 for the sampling clock edge at which assertion of the incoming timing pulse signal 24 is detected. In the latter case, the timing circuit 10 may maintain a running buffer of two or more clock cycles worth of captured states of the incoming timing pulse signal 24, and then freeze that buffer for evaluation in response to detecting assertion of the incoming timing pulse signal 24 at a given sampling clock edge. In other words, the delay circuit 18 does not have to operate on the exact clock cycle in which the incoming timing pulse signal 24 arrived.

Of further note, the delay circuit 18 could identify the leading edge of the incoming timing pulse signal 24 more than once. For example, depending on PVT factors, and on the length of the tapped delay line 62 and the propagation delay value(s) of the individual delay stages 64, the propagation delay circuit 60 could identify an edge more than once. The compensation circuit 20 can be configured to handle such cases by calculating the timing difference according to the “first” one of these edges. The particular edge that is “first” among two or more edges observed in the captured states is the one associated with the earliest incremental delay. Further, as detailed elsewhere herein, the propagation delay circuit 60 and, more generally, the delay circuit 18, may include more than one level of flip-flops or other capture circuitry, for more robust flip-flop based capture. Still further, detection can be based on rising edges, falling edges, or both.

Turning to example timing compensation details, in one or more embodiments, the processing circuitry 28 is configured to compensate the timing operation of the timing circuit 10 according to the estimated timing difference by setting a fractional timing clock adjustment for a synchronization timing clock 22 in dependence on the estimated timing difference. For example, the processing circuitry 28 is configured to set the fractional timing clock adjustment by setting a counter value corresponding to fractions of the sampling clock period to a value corresponding to a known cumulative delay associated with the incremental delay or delays at which assertion of the incoming timing pulse signal is observed.

In an example, the incoming timing pulse signal 24 is a “Pulse Per Second” or “PPS” signal in a distributed timing network, such as in an IEEE 1588 network. The synchronization timing clock 22 comprises a local time clock that counts or at least has adjustments for seconds, nanoseconds, and fractions of nanoseconds. If the sampling clock signal 30 is a 1 GHz signal, the corresponding sampling clock period is 1 nanosecond. Thus, detecting the arrival time of the PPS signal at the resolution of the sampling clock signal 30 provides a nominal resolution of one nanosecond. However, detection is vulnerable to jitter arising from metastability issues, such as where the assertion of the PPS signal coincides with a sampling clock edge, and, more fundamentally, arising from the simple fact that the PPS assertion is asynchronous with respect to the sampling clock signal 30.

In this context, the timing circuit 10 uses the incrementally delayed versions of the incoming timing pulse signal 24 or sampling clock signal 30 to estimate the timing difference between the detected PPS time of arrival and its actual time of arrival with sub-nanosecond resolution. For example, the timing circuit 10 uses a base incremental delay of d=100 picoseconds, and for a given arrival event the timing circuit 10 estimates from the captured digital word described above that the actual arrival time occurred 5 d unit times before the detected arrival time—i.e., 5 d unit times in advance of the clock edge of the sampling clock signal 30 at which the assertion was detected.

This information allows the timing circuit 10 to set the counter register corresponding to the fractions of nanoseconds. For example, the fractional nanosecond counter is set to a value of 500 picoseconds, to reflect the estimated timing difference of 5 d unit delays in the above example. Thus, the overall update of the synchronization clock 22 is refined by an accurately estimated sub-nanosecond estimate. Of course, other time scales having finer or coarser timing resolutions may be implemented using the same techniques.

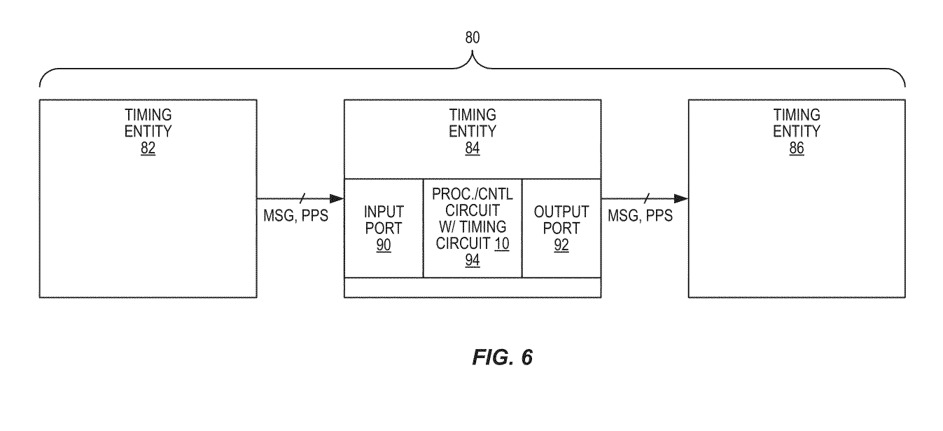

With the above non-limiting example in mind, and with reference to FIG. 6, the timing circuit 10 is configured to operate in a distributed timing system 80 that includes a number of timing entities 82, 84 and 86. These entities may operate in various master/slave relationships in terms of time synchronization.

In the example illustration, an incoming timing pulse signal 24 from the timing entity 82 is used as a master clock timing reference with respect to the timing circuit 10 operating within the timing entity 84. In particular, the incoming PPS signal is received at the timing entity 84 at an input port 90 and an associated processing/control circuit 94 will be understood as containing or implementing an example of the previously described timing circuit 10. The timing entity 84 also may provide a master clock reference to the timing entity 86, via an output port 92.

The output port 92 may use, for example, the output timing signal adjustments described later herein. In any case, the processing circuitry 28 within the timing circuit 10 of the timing entity 84 is configured to compensate the timing operation of the timing circuit 10 according to the estimated timing difference by adjusting the synchronization timing clock 22 of the timing circuit 10 to account for the timing difference.

One aspect of the teachings herein therefore is the improved accuracy of adjustment provided by the timing circuit 10, with respect to one or more timer/counters that are adjusted, reset or otherwise updated in response to receiving an incoming asynchronous pulse. In a typical example in such systems, a Pulse Per Second or PPS signal comes in, and an ASIC or other such circuitry captures the Time of Day and/or an Epoch/48-bit free running counter. The accuracy of the clock used to measure or detect the pulse limits the accuracy at which the arrival time of the pulse is determined. For example, in the case of a 250 MHz clock, when the edge-based capture could be off by two clock cycles, the jitter seen would be eight nanoseconds of error. The timing circuit 10, as taught herein, is configured to eliminate or reduce such jitter and thereby provide for more accurate adjustment of the corresponding counters or timers, e.g., either in hardware or in software.

In other words, the timing circuit 10 reveals the timing difference or offset between detected arrival times for an incoming asynchronous pulse and the actual arrival times, as measured on a time scale finer than the resolution of the clock signal used to detect arrival. The timing circuit 10 thereby allows a timing function, e.g., a software-based clock update routine, to more precisely determine the arrival time of the incoming pulse in relation to the circuit's clock. Much more accurate time stamping is thus enabled.

Consider an example method or set of processing operations in which an incoming PPS signal arrives and is sampled using a sampling clock, which can be denoted as “TSClock”. The TSClock is a 1 GHz clock signal having a corresponding, nominal timing resolution of one nanosecond. Detecting the PPS signal arrival time via the TSClock can be understood as transforming the PPS into the TSClock timing domain, inasmuch as the arrival time is known in terms of the TSClock edge at which the arrival was detected. This edge-based detection triggers, for example, the capture and storage or saving of the then-current values of a timer/counter.

However, the timing circuit 10 disclosed herein provides a mechanism for estimating timing difference between the arrival time of the PPS signal as detected by the TSClock and the actual arrival time, at a timing resolution finer than that afforded by the TSClock. For example, the timing circuit 10 can be configured such that the delay circuit 18 uses delay increments of 100 picoseconds or less, thus providing a timing resolution improvement of a factor of ten or greater. Moreover, in at least some embodiments, the higher resolution timing is obtained by exploiting the propagation delays of basic logic gates, e.g., inverters, AND gates, etc. In other embodiments, a digital PLL circuit operates with clock phases that are increments of the fundamental clock period, to obtain the finer timing resolution.

In either case, determining the timing difference between the actual arrival time of the PPS signal and the clock-detected arrival time at a sub-clock timing resolution allows the timing circuit 10 or associated circuitry within the associated timing entity to more accurately update the timer/counter values corresponding to the PPS arrival time. For example, assume that the associated timing entity includes a seconds counter, a nanoseconds counter, and a fractional nanoseconds counter, and assume that TSClock has a one-nanosecond resolution. The value of the seconds/nanoseconds counters are captured in response to detecting the PPS signal arrival on a sampling edge of the TSClock, and the timing circuit 10 is used to estimate the fractional timing difference between that apparent, clock-detected arrival time and the actual arrival time. The estimated timing difference is then used to update the fractional nanosecond register, which means that the corresponding clock adjustment reflects a timing resolution better than that afforded by the TSClock, and advantageously does so without requiring a more precise or more stable clock.

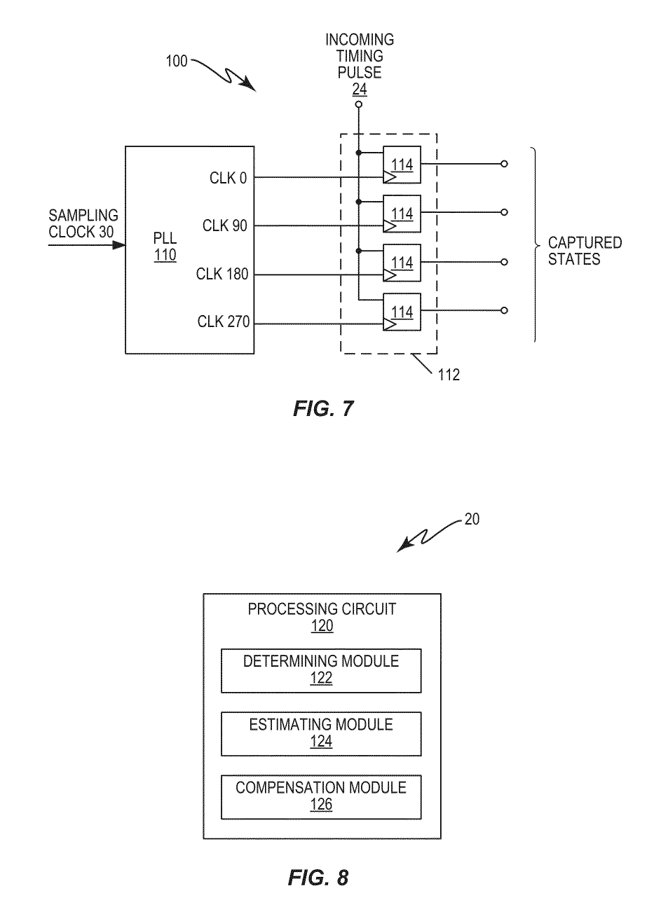

FIG. 7 illustrates yet another embodiment for implementing the delay circuit 18 introduced in FIG. 1. Here, Phase Locked Loop, PLL, circuitry 100 functions as another example embodiment of the delay circuit 18. In more detail, the processing circuitry 28 in such embodiments is configured to generate delayed versions of the sampling clock signal 30 via PLL circuit 110 that provides a plurality of clock phases, with each clock phase corresponding to one of the delayed versions of the sampling clock signal 30. Each clock phase clocks a respective register 114 in a parallel set 112 of registers 114 used to capture the state of the incoming timing pulse signal 24. As seen in previous variations, these incrementally delayed versions of the sampling clock signal 30 enable the timing circuit 10 to capture the state of the incoming timing pulse signal 24 at incremental timing offsets relative to the sampling clock edge at which assertion of the incoming timing pulse signal 24 is detected.

Regardless of whether the incoming timing pulse signal 24 is delayed, or whether the sampling clock signal 30 is delayed, and regardless of whether the delays are created using a PLL, a tapped delay line, or using another circuit arrangement, the processing circuitry 28 in one or more embodiments comprises a capture circuit 14 that is configured to generate the delayed versions of the incoming timing pulse signal 24 or the sampling clock signal 30, and a compensation circuit 20 that is configured to: (1) determine the state of the incoming timing pulse signal 24 for each of the incremental delays, (2) estimate the timing difference between the actual assertion time of the incoming timing pulse signal 24 and the sampling clock edge at which assertion of the incoming timing pulse signal 24 is detected, based on the determined states, and (3) compensate the timing operation of the timing circuit 10 according to the estimated timing difference.

The processing circuitry 28 comprises, for example, a mix of fixed and programmed circuitry. In one such embodiment, certain elements of the capture circuit 14 comprise fixed or discrete hardware circuits, such as propagation delay elements—digital logic gates or other such circuits—while at least some of the elements comprising the compensation circuit 20 comprise programmed digital circuitry. For example, the compensation circuit 20 may comprise or include a microprocessor, DSP, FPGA, or other such digital processing circuitry having circuit configurations realized based on the execution of stored computer program instructions. In such embodiments the processing circuitry 28 includes one or more memory circuits or other computer-readable media that provides non-transitory storage for the computer program instructions to be executed by the processing circuitry 28.

In an example computer-implemented embodiment, the compensation circuit 20 comprises functional modules, such as are illustrated in the example of FIG. 8. Here, the compensation circuit 20 includes a processing circuit 120—e.g., a DSP, FPGA, ASIC, microprocessor, or other digital processing circuitry—that is functionally arranged as a determining module 122 configured to determine the state of the incoming timing pulse signal 24 for each of the incremental delays, an estimating module 124 configured to estimate the timing difference between the actual assertion time of the incoming timing pulse signal 24 and the sampling clock edge at which assertion of the incoming timing pulse signal 24 is detected, based on the determined states, and a compensating module 126 configured to compensate the timing operation of the timing circuit 10 according to the estimated timing difference.

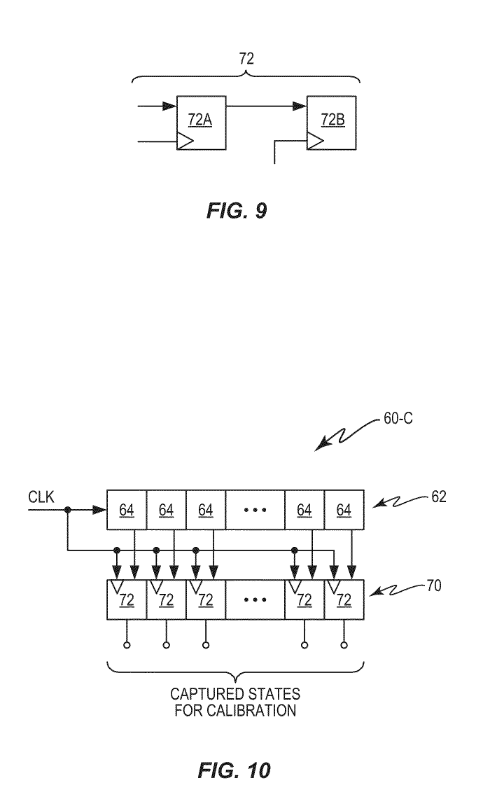

In other example details of interest, FIG. 9 uses the capture registers 72 introduced in FIG. 4 as an example of how metastability issues may be addressed in the context of using registers to capture signal states. Metastability represents an undefined state or operation of the register and arises, for example, when signal transitions on its clock and data inputs occur at or around the same time instant. Metastiblity thus may compromise the accuracy of the delay-based timing difference determination presented herein, and FIG. 9 illustrates that each capture register 72 may be implemented as a two-stage capture register having registers 72A feeding register 72B. The same dual-flop implementation may apply, of course, to the registers 50 introduced in FIG. 3.

Further, there are other ways to address metastability beyond double flopping the samples. In one variation contemplated herein, the registers in question are implemented using “hardened” flops, which are known in the industry and which are significantly less likely to suffer metastability problems. Yet another approach contemplated herein is to take an average over multiple samples, and removing the outliers. For example, if most observations of the timing difference implicate, e.g., the ninth or tenth delay tap of a tapped delay line, while a few observations implicate the eighth and twelfth taps, the latter taps may be considered as outliers.

In a further refinement seen in FIG. 10, the timing circuit 10 includes a propagation delay circuit 60-C, where “C” denotes calibration use. The delay circuit 60-C allows the timing circuit 10 to learn or adapt the time values it attributes to the incremental delays imparted to the incoming timing pulse signal 24 or the sampling clock signal 30. For example, assume that the delay circuit 18 is implemented as the propagation delay circuit 60 and includes a tapped delay line 62, such as seen in FIG. 4 or FIG. 5. An identical tapped delay line 62, or as nearly identical as can be achieved, is implemented by the propagation delay circuit 60-C, and the sampling clock signal 30 is propagated through this identical tapped delay line 62, and used to capture the corresponding delayed states at sampling clock edges. In this manner, the timing circuit 10 can determine estimates of the actual propagation delays imparted by the stages 64 of the tapped delay line 62 of the propagation delay circuit 60-C.

By placing the propagation delay circuit 60-C in close proximity on the integrated circuit die to the propagation delay circuit 60, and by using the same supply voltage, etc., the timing circuit 10 can infer that propagation delays seen in the propagation delay circuit 60-C mirror those of the propagation delay circuit 60. As such, when using the actual propagation delay circuit 60 used to determine the timing difference between the actual assertion of the incoming timing pulse signal 24 and the sampling clock edge at which assertion is detected, the timing circuit 10 can use calibrated values of the time increment(s) “d”, rather than simply using fixed, preconfigured values. Alternatively, the timing circuit 10 uses a fixed value or values for “d”, but applies a scaling to the estimated timing difference, based on its observations of actual timing in the circuit 60-C.

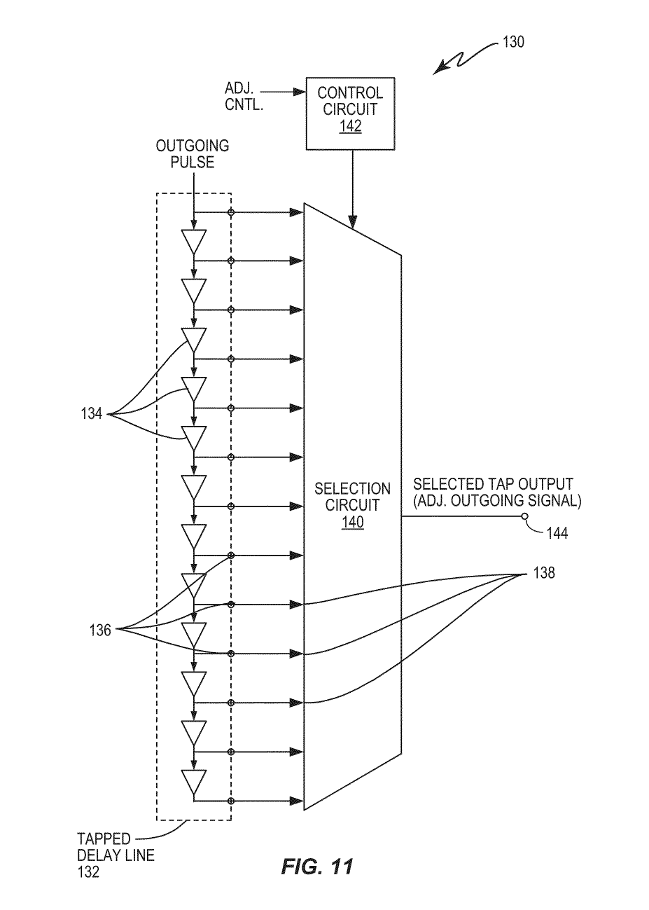

FIG. 11 illustrates another embodiment, in which an output signal circuit 130 uses a delay circuit which is used to adjust the actual hardware departure time of an outgoing timing pulse signal by fractions of the sampling clock period associated with generation of the outgoing signal. In the example arrangement, the delay circuit is implemented as a tapped delay line 132 having a plurality of delay stages 134 in a series arrangement. Each delay stage 134 imparts a propagation delay of, say, 50-100 picoseconds. As such, by propagating the outgoing timing pulse signal through the tapped delay line 132, the output signal circuit 130 obtains a plurality of delayed versions of the outgoing signal at delay increments comprising a fraction of the sampling clock period associated with generation of the outgoing timing pulse signal.

Respective ones among the plurality of delayed versions of the outgoing timing pulse signal are provided on delay taps 136 of the tapped delay line 132, and are coupled into respective signal inputs 138 of a selection circuit 140. In some sense, the selection circuit 140 can be understood as a multiplexer by which a control circuit 142 selects which delay tap signal from the tapped delay line 132 is output from the selection circuit 140, as the “adjusted” or “final” version of the outgoing timing pulse signal.

Broadly, the contemplated outgoing signal circuit 130 comprises a propagation delay circuit, such as the illustrated tapped delay line 132, which is configured to provide a plurality of delayed versions of an outgoing timing pulse signal at respective incremental delays. The propagation delay circuit 132 provides the delayed versions of the outgoing timing pulse signal at respective delay taps 136 corresponding to the incremental delays. In turn, the selection circuit 140 is configured to couple a selected one of the delayed versions of the outgoing timing pulse signal to an output port 144 of the output signal circuit 130. The control circuit 142 is configured to determine a timing adjustment and to correspondingly control the selection circuit 140 to select the delayed version of the outgoing timing pulse signal that corresponds to the timing adjustment, as the “selected one” of the delayed versions of the outgoing timing pulse signal.

In one example, the nominal departure time of the outgoing timing pulse signal may be generated to account for, e.g., half the delay of the tapped delay line 132, meaning that the nominal, zero-adjustment version of the outgoing signal is taken from the delay tap 136 at the halfway point in the tapped delay line. The control circuit 142 can then obtain an earlier departure time by selecting an earlier delay tap 136, or obtain a later departure time by selecting a later delay tap 136. In this and in other embodiments, the control circuit 142 may control the selection circuit 140 responsive to an adjustment control signal applied to the control circuit 142. The adjustment control signal is, for example, generated by determining the fractional timing error of the local clock used at the timing entity that contains the outgoing signal circuit 130.

Whether viewed in the context of more accurately detecting the arrival time of an incoming timing pulse signal, or in the context of more accurately adjusting the departure time of an outgoing timing pulse signal, the teachings presented herein provide for timing circuitry that operates with sub-nanosecond errors and thereby improves the synchronization performance of a wide range of products, such as network routers and switches—sometimes referred to as “pizza boxes”—operating in a communication network, such as the backhaul network in a mobile telecommunications system. Moreover, these performance improvements are accompanied by potential cost reductions. For example, a pizza box implementing the disclosed techniques may be able to use a Stratum 3 Oven Control Oscillator (OCXO) with a stability of (3.7×10-7)/day instead of a Stratum 3E OCXO with a stability of (1×10-8)/day and still be able to meet IEEE 1588 synchronization hop requirements.

By reducing the jitter in the system, and by using this more precise arrival and/or departure time teachings presented herein, the pizza box could use the less stable, less expensive oscillator or another less expensive IEEE1588 solution. Thus, it may be possible to have a stuffing option for the oscillator that would allow for less expensive oscillators to be stuffed based on individual customer requirements. However, if the more expensive Stratum 3E clock source is required for another purpose—e.g., for use in a SYNC-E system—then the selection of the oscillator would be dictated by that purpose and not the IEEE 1588 requirements.

In any case, according to the teachings herein, the arrival or departure timestamp is taken to the edge of the MAC/PHY/SERDES to remove all errors that may occur in a clock control module operating inside a timing-related ASIC or other timing circuitry. Here, “MAC” denotes the Medium Access Layer in a layered network model, “PHY” denotes the Physical Layer in that network model, and “SERDES” denotes the Serializer/De-serializer circuitry used in such systems, to serialized parallel data for transmission between nodes. In these contexts, the teachings disclosed herein are operative to reduce the timing errors to the sub-nanosecond level, thereby enhancing the synchronization of the ASIC, chassis, and/or multi-chassis. Such improvements improve the synchronization performance of systems or subsystems, while simultaneously allowing for the use of less stable, less expensive crystal oscillators or other less expensive synchronization circuitry.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method in a timing circuit comprising:
detecting assertion of an incoming timing pulse signal, via a sampling clock edge of a sampling clock signal having a sampling clock period;
generating delayed versions of the incoming timing pulse signal or the sampling clock signal, wherein the delayed versions are separated by incremental delays that are fractions of the sampling clock period;
determining the state of the incoming timing pulse signal for each of the incremental delays;
estimating a timing difference between an actual assertion time of the incoming timing pulse signal and the sampling clock edge at which assertion of the incoming timing pulse signal is detected, based on the determined states; and
compensating a timing operation of the timing circuit according to the estimated timing difference.

2. The method of claim 1, wherein generating the delayed versions of the incoming timing pulse signal or the sampling clock signal comprises propagating the incoming timing pulse signal or the sampling clock signal through a propagation delay circuit having delay taps corresponding to the incremental delays.

3. The method of claim 1, wherein determining the state of the incoming timing pulse signal for each of the incremental delays comprises capturing the state of the incoming timing pulse signal at each incremental delay and determining from the captured states the incremental delay or delays at which assertion of the incoming timing pulse signal is observed.

4. The method of claim 1,
wherein generating the delayed versions of the incoming timing pulse signal or the sampling clock signal comprises generating delayed versions of the incoming timing pulse signal; and
wherein determining the state of the incoming timing pulse signal for each of the incremental delays comprises:
applying each delayed version of the incoming timing pulse signal to a data input of a respective register in a parallel set of registers; and
obtaining a digital word by clocking the parallel set of registers via the sampling clock edge at which the assertion of the incoming timing pulse signal is detected; and
wherein estimating the timing difference between the actual assertion time of the incoming timing pulse signal and the sampling clock edge at which assertion of the incoming timing pulse signal is detected comprises identifying, from the bit values in the digital word, the incremental delay or delays at which the assertion of the incoming timing pulse signal is observed.

5. The method of claim 4, further comprising generating the delayed versions of the incoming timing pulse signal in a parallel propagation delay circuit having a plurality of propagation delay branches, each branch having a propagation delay value corresponding to one of the incremental delays, or generating the delayed versions of the incoming pulse timing signal in a series propagation delay circuit having a plurality of delay stages arranged in series as a tapped delay line, where each delay stage has a propagation delay value corresponding to one of the incremental delays.

6. The method of claim 1,
wherein generating the delayed versions of the incoming timing pulse signal or the sampling clock signal comprises generating delayed versions of the sampling clock signal; and
wherein determining the state of the incoming timing pulse signal for each of the incremental delays comprises:
applying the incoming timing pulse signal to a data input of a respective register in a parallel set of registers; and
obtaining a digital word by clocking respective ones in the parallel set of registers with the delayed versions of the sampling clock signal; and
wherein estimating the timing difference between the actual assertion time of the incoming timing pulse signal and the sampling clock edge at which assertion of the incoming timing pulse signal is detected comprises identifying from the bit values in the digital word the incremental delay or delays at which the assertion of the incoming timing pulse signal is observed.

7. The method of claim 1, wherein estimating the timing difference comprises identifying at which incremental delay the incoming timing pulse signal is observed in an asserted state, and estimating the timing difference based on a known cumulative delay associated with the identified incremental delay.

8. The method of claim 1, wherein compensating the timing operation of the timing circuit according to the estimated timing difference comprises setting a fractional timing clock adjustment for a synchronization timing clock in dependence on the estimated timing difference.

9. The method of claim 8, wherein setting the fractional timing clock adjustment comprises setting a counter value corresponding to fractions of the sampling clock period to a value corresponding to a known cumulative delay associated with the incremental delay or delays at which the assertion of the incoming timing pulse signal is observed.

10. The method of claim 1, wherein the timing circuit is configured to operate in a distributed timing system in which the incoming timing pulse signal is used as a master clock timing reference with respect to the timing circuit, and wherein compensating the timing operation of the timing circuit according to the estimated timing difference comprises adjusting a synchronization timing clock of the timing circuit to account for the estimated timing difference.

11. The method of claim 1, wherein generating delayed versions of the incoming timing pulse signal or the sampling clock signal comprises generating delayed versions of the sampling clock signal via a Phase Locked Loop, PLL circuit that provides a plurality of clock phases, with each clock phase corresponding to one of said delayed versions of the sampling clock signal, and where each clock phase clocks a respective register in a parallel set of registers used to capture the state of the incoming timing pulse signal.

12. An output signal circuit comprising:
a propagation delay circuit configured to provide a plurality of delayed versions of an outgoing timing pulse signal at respective incremental delays, said propagation delay circuit providing the delayed versions of the outgoing timing pulse signal at respective delay taps corresponding to the incremental delays;
a selection circuit configured to couple a selected one of the delayed versions of the outgoing timing pulse signal to an output port of the output signal circuit; and
a control circuit configured to determine a timing adjustment and to correspondingly control the selection circuit to select the delayed version of the outgoing timing pulse signal that corresponds to the timing adjustment, as said selected one of the delayed versions of the outgoing timing pulse signal.

13. A timing circuit comprising:
an input connection configured to receive an incoming timing pulse signal; and
processing circuitry configured to:
detect assertion of the incoming timing pulse signal, via a sampling clock edge of a sampling clock signal having a sampling clock period;
generate delayed versions of the incoming timing pulse signal or the sampling clock signal, wherein the delayed versions are separated by incremental delays that are fractions of the sampling clock period;
determine the state of the incoming timing pulse signal for each of the incremental delays;
estimate a timing difference between an actual assertion time of the incoming timing pulse signal and the sampling clock edge at which assertion of the incoming timing pulse signal is detected, based on the determined states; and
compensate a timing operation of the timing circuit according to the estimated timing difference.

14. The timing circuit of claim 13, wherein the processing circuitry is configured to generate the delayed versions of the incoming timing pulse signal or the sampling clock signal by propagating the incoming timing pulse signal or the sampling clock signal through an included propagation delay circuit having delay taps corresponding to the incremental delays.

15. The timing circuit of claim 13, wherein the processing circuitry is configured to determine the state of the incoming timing pulse signal for each of the incremental delays by capturing the state of the incoming timing pulse signal at each incremental delay and determining from the captured states the incremental delay or delays at which assertion of the incoming timing pulse signal is observed.

16. The timing circuit of claim 13,
wherein the processing circuitry is configured to generate the delayed versions of the incoming timing pulse signal or the sampling clock signal by generating delayed versions of the incoming timing pulse signal; and
wherein the processing circuitry is configured to determine the state of the incoming timing pulse signal for each of the incremental delays based on being configured to:
apply each delayed version of the incoming timing pulse signal to a data input of a respective register in a parallel set of registers; and
obtain a digital word by clocking the parallel set of registers via the sampling clock edge at which the assertion of the incoming timing pulse signal is detected; and
wherein the processing circuitry is configured to estimate the timing difference between the actual assertion time of the incoming timing pulse signal and the sampling clock edge at which assertion of the incoming timing pulse signal is detected by identifying, from the bit values in the digital word, the incremental delay or delays at which the assertion of the incoming timing pulse signal is observed.

17. The timing circuit of claim 16, wherein the processing circuitry is configured to generate the delayed versions of the incoming timing pulse signal in a parallel propagation delay circuit having a plurality of propagation delay branches, each branch having a propagation delay value corresponding to one of the incremental delays, or to generate the delayed versions of the incoming timing pulse signal in a series propagation delay circuit having a plurality of delay stages arranged in series as a tapped delay line, where each delay stage has a propagation delay value corresponding to one of the incremental delays.

18. The timing circuit of claim 13,
wherein the processing circuitry is configured to generate the delayed versions of the incoming timing pulse signal or the sampling clock signal by generating delayed versions of the sampling clock signal; and
wherein the processing circuitry is configured to determine the state of the incoming timing pulse signal for each of the incremental delays based on being configured to:
apply the incoming timing pulse signal to a data input of a respective register in a parallel set of registers; and
obtain a digital word by clocking respective ones in the parallel set of registers with the delayed versions of the sampling clock signal; and
wherein the processing circuitry is configured to estimate the timing difference between the actual assertion time of the incoming timing pulse signal and the sampling clock edge at which assertion of the incoming timing pulse signal is detected by identifying, from the bit values in the digital word, the incremental delay or delays at which the assertion of the incoming timing pulse signal is observed.

19. The timing circuit of claim 13, wherein the processing circuitry is configured to estimate the timing difference by identifying at which incremental delay the incoming timing pulse signal is observed in an asserted state, and estimating the timing difference based on a known cumulative delay associated with the identified incremental delay.

20. The timing circuit of claim 13, wherein the processing circuitry is configured to compensate the timing operation of the timing circuit according to the estimated timing difference by setting a fractional timing clock adjustment for a synchronization timing clock in dependence on the estimated timing difference.

21. The timing circuit of claim 20, wherein the processing circuitry is configured to set the fractional timing clock adjustment by setting a counter value corresponding to fractions of the sampling clock period to a value corresponding to a known cumulative delay associated with the incremental delay or delays at which the assertion of the incoming timing pulse signal is observed.

22. The timing circuit of claim 13, wherein the timing circuit is configured to operate in a distributed timing system in which the incoming timing pulse signal is used as a master clock timing reference with respect to the timing circuit, and wherein the processing circuitry is configured to compensate the timing operation of the timing circuit according to the estimated timing difference by adjusting a synchronization timing clock of the timing circuit to account for the estimated timing difference.

23. The timing circuit of claim 13, wherein the processing circuitry is configured to generate delayed versions of the incoming timing pulse signal or the sampling clock signal by generating delayed versions of the sampling clock signal via a Phase Locked Loop, PLL, circuit that provides a plurality of clock phases, with each clock phase corresponding to one of said delayed versions of the sampling clock signal, and where each clock phase clocks a respective register in a parallel set of registers used to capture the state of the incoming timing pulse signal.

24. The timing circuit of claim 13, wherein the processing circuitry comprises a capture circuit configured to generate the delayed versions of the incoming timing pulse signal or the sampling clock signal, and a compensation circuit configured to:
determine the state of the incoming timing pulse signal for each of the incremental delays;
estimate the timing difference between the actual assertion time of the incoming timing pulse signal and the sampling clock edge at which assertion of the incoming timing pulse signal is detected, based on the determined states; and
compensate the timing operation of the timing circuit according to the estimated timing difference.

25. The timing circuit of claim 13, wherein the processing circuitry comprises:
a determining module configured to determine the state of the incoming timing pulse signal for each of the incremental delays;
an estimating module configured to estimate the timing difference between the actual assertion time of the incoming timing pulse signal and the sampling clock edge at which assertion of the incoming timing pulse signal is detected, based on the determined states; and
a compensating module configured to compensate the timing operation of the timing circuit according to the estimated timing difference.
